(19) United States
(12) Patent Application Publication
(10) Pub. No.: US 2008/0278672 A1
(43) Pub. Date: Nov. 13, 2008

(54) PRESSURE-SENSITIVE ADHESIVE OPTICAL FILM AND IMAGE DISPLAY

(75) Inventors: Kohei YANO, Osaka (JP); Akiko SUGINO, Osaka (JP); Tsuyoshi CHIBA, Osaka (JP); Masayuki SATAKE, Osaka (JP); Kayo OOHIRA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/116,596

(22) Filed: May 7, 2008

(30) Foreign Application Priority Data
May 8, 2007 (JP) 2007-123674
Mar. 21, 2008 (JP) 2008-073764

(51) Int. Cl. C09K 19/02; G02B 1/02

(52) U.S. Cl. 349/193; 430/20

(57) ABSTRACT

A pressure-sensitive adhesive optical film of the present invention comprises: an optical film comprising a transparent base film and a discotic liquid crystal layer provided on one side of the transparent base film; an undercoat layer; and a pressure-sensitive adhesive layer provided on the discotic liquid crystal layer with the undercoat layer interposed therebetween, the undercoat layer comprises a polymer and an antioxidant; and the pressure-sensitive adhesive layer comprises a (meth)acrylic polymer (A) comprising 80 to 99.5% by weight of an alkyl (meth)acrylate monomer unit and 0.05 to 3% by weight of a hydroxyl group-containing monomer unit and having a weight average molecular weight of 1,000,000 to 2,500,000; a (meth)acrylic oligomer (B) comprising 80 to 99.9% by weight of an alkyl (meth)acrylate monomer unit and 0.1 to 3% by weight of a carboxyl group-containing monomer unit and having a weight average molecular weight of 3,000 to 8,000; a crosslinking agent (C); and a silane coupling agent (D), and the pressure-sensitive adhesive layer comprises 10 to 40 parts by weight of the (meth)acrylic oligomer (B) based on 100 parts by weight of the (meth)acrylic polymer (A). The pressure-sensitive adhesive optical film has durability and can suppress display unevenness in a peripheral portion of a display screen and window frame unevenness in a state that a backlight is on.

### BACKGROUND OF THE INVENTION

1. Field of the Invention

The present invention relates to a pressure-sensitive adhesive optical film. The present invention also relates to an image display, such as a liquid crystal display, an organic electroluminescent display, a cathode ray tube (CRT), and a plasma display panel (PDP), using the pressure-sensitive adhesive optical film.

The pressure-sensitive adhesive optical film of the present invention has an aligned discotic liquid crystal layer and is useful as an optical compensation film to improve display contrast and the viewing angle characteristics of displayed colors. In particular, the pressure-sensitive adhesive optical film having a polarizer laminated therein is useful as an elliptically polarizing plate with the function of optical compensation.

2. Description of the Related Art

The liquid crystal display market has rapidly expanded in such fields as clocks, mobile phones, PDAs, note PCs, PC monitors, DVD players, and TVs. Liquid crystal displays use liquid crystal switching to visualize changes in polarization state, and based on the display principle, they use polarizers. Particularly in TV applications and the like, there is an increasing demand for high brightness and high contrast display, and thus brighter (higher transmittance) and higher contrast (higher degree of polarization) polarizers have been developed and introduced.

The currently dominating type of general liquid crystal displays is a TFT-LCD using a TN liquid crystal. This type has the advantages of a high response speed and a capability of producing high contrast. However, if displays on TN liquid crystal panels are viewed at angles oblique to the normal direction, their contrast can be significant low, or gradation reversal, an event in which the gradation of displays is inverted, or the like can take place. Thus, TN liquid crystals have very narrow viewing angle characteristics. On the other hand, applications such as large PC monitors and large screen televisions should satisfy certain requirements such as high contrast, wide viewing angle, and little fluctuation in display colors over viewing angles. Thus, TN mode TFT-LCDs for use in such applications must have a retardation film for compensating for viewing angles.

Conventionally, stretched birefringent polymer films have been used as the retardation film. Recently, it has been proposed that the optical compensation film made of such a stretched birefringent film is replaced with another optical compensation film having an optically anisotropic layer formed of a liquid crystalline molecule on a transparent support. Since liquid crystalline molecules can have various orientation modes, the use of liquid crystalline molecules has enabled the achievement of certain optical properties that had not been achieved with conventional stretched birefringent polymer films.

For example, one of the proposed retardation films for viewing angle compensation is Wide View Film manufactured by Fuji Photo Film Co., Ltd., which uses a discotic liquid crystal with negative refractive index anisotropy (see JP-A No. 08-95032 and JP-B No. 2767382). This retardation film includes a transparent base film and a discotic liquid crystal layer that is provided on one side of the base film and has an obliquely-oriented optical axis. The main purpose of this retardation film is to improve viewing angle characteristics in a state where a certain voltage for black viewing is applied. Specifically, in a state where a certain voltage is applied, a liquid crystal molecule in a liquid crystal cell shows positive refractive index anisotropy with an optical axis tilted with respect to a glass substrate. In order to compensate for the retardation caused by this refractive index anisotropy, the retardation film uses a liquid crystalline molecule having an optical axis tilted with respect to the film normal direction and having negative refractive index anisotropy.

In the retardation film for viewing angle compensation, a polarizer is laminated on the transparent base film to form an elliptically polarizing plate, and a pressure-sensitive adhesive is laminated on the discotic liquid crystal layer. The pressure-sensitive adhesive optical film having the pressure-sensitive adhesive layer laminated therein and serving as a retardation film, an elliptically polarizing plate, or the like is bonded to a liquid crystal cell or the like through the pressure-sensitive adhesive layer. The above-mentioned retardation film for viewing angle compensation or the above-mentioned elliptically polarizing plate may be bonded to a liquid crystal cell or the like through the pressure-sensitive adhesive layer to form a liquid crystal display. When used in combination with a backlight in a lighting state, however, such a liquid crystal display has a problem in which unevenness occurs in the vicinity of the frame of the liquid crystal display (hereinafter, this is referred to as “window frame unevenness”) to reduce visibility. Particularly when the temperature is high or when the size of the liquid crystal display is large, the window frame unevenness becomes significant.

Acrylic pressure-sensitive adhesives including an acrylic polymer as a base polymer are frequently used for the optical films with a pressure-sensitive adhesive, because of such as their excellent adhesive property and transparency. Methods for crosslinking acrylic pressure-sensitive adhesives often use isocyanate-based crosslinking agents, and a coupling with functional monomers copolymerized in the acrylic polymer is mainly used in such methods.

Such optical films are bonded to liquid crystal cells to form liquid crystal panels, which are used and incorporated into liquid crystal displays. Liquid crystal displays have been used at first for calculators and later for such as watches, televisions and monitors. Since liquid crystal displays are placed under various conditions such as a heat condition and a humidification condition and thus required to have high durability such that display quality is not deteriorated under such environments.

When liquid crystal displays are placed under the heat or the humidification condition, however, display unevenness can sometimes occur in the peripheral portion of the liquid crystal panel to cause display defects. The display unevenness in the peripheral portion can be significantly found, particularly when the above-mentioned retardation film for viewing angle compensation or the above-mentioned elliptically polarizing plate is used.

In order to improve the display unevenness in the peripheral portion, it is proposed that a pressure-sensitive adhesive composition containing a plasticizer or an oligomer component is used as a pressure-sensitive adhesive used for the optical film with a pressure-sensitive adhesive (see JP-A No. 09-87593 and 10-279907). However, such a pressure-sensitive adhesive composition has a problem in which additives such as the plasticizer or the oligomer component can be precipitated to cause defects in appearance or degradation of the pressure-sensitive adhesive in a long-time heating test.

### SUMMARY OF THE INVENTION

It is an object of the invention to provide a pressure-sensitive adhesive optical film that includes a transparent base film, in which a discotic liquid crystal layer is provided on one side of the transparent base film and a pressure-sensitive adhesive layer is laminated on the discotic liquid crystal layer, and the pressure-sensitive adhesive optical film has durability and can suppress display unevenness in a peripheral portion of a display screen and window frame unevenness in a state that a backlight is on.

It is another object of the present invention to provide an image display using such a pressure-sensitive adhesive optical film.

As a result of investigation for solving the problems, the inventors have found that the objects can be achieved with the pressure-sensitive adhesive optical film described below, and has finally completed the present invention.

The present invention relates to a pressure-sensitive adhesive optical film, comprising:
an optical film comprising a transparent base film and a discotic liquid crystal layer provided on one side of the transparent base film;
an undercoat layer; and
a pressure-sensitive adhesive layer provided on the discotic liquid crystal layer with the undercoat layer interposed therebetween,
the undercoat layer comprises a polymer and an antioxidant; and
the pressure-sensitive adhesive layer comprises a (meth)acrylic polymer (A) comprising 80 to 99.5% by weight of an allyl (meth)acrylate monomer unit and 0.05 to 3% by weight of a hydroxyl group-containing monomer unit and having a weight average molecular weight of 1,000,000 to 2,500,000;
a (meth)acrylic oligomer (B) comprising 80 to 99.9% by weight of an alkyl (meth)acrylate monomer unit and 0.1 to 3% by weight of a carboxyl group-containing monomer unit and having a weight average molecular weight of 3,000 to 8,000;
a crosslinking agent (C); and
a silane coupling agent (D), and
the pressure-sensitive adhesive layer comprises 10 to 40 parts by weight of the (meth)acrylic oligomer (B) based on 100 parts by weight of the (meth)acrylic polymer (A).

In the pressure-sensitive adhesive optical film, the polymer of the undercoat layer preferably has a primary amino group.

And the polymer having the primary amino group is preferably a poly (meth)acrylate having a primary amino group at its end.

In the pressure-sensitive adhesive optical film, the antioxidant is preferably at least one selected from a phenolic antioxidant, a phosphorus antioxidant, a sulfur antioxidant, and an amine antioxidant.

In the pressure-sensitive adhesive optical film, the undercoat layer preferably contains 0.01 to 1000 parts by weight of the antioxidant based on 100 parts by weight of the polymer.

In the pressure-sensitive adhesive optical film, the optical film further preferably comprises a polarizer and a protective film layer laminated on one side of the transparent base film where the discotic liquid crystal layer is not formed with the polarizer interposed therebetween.

And the protective film layer preferably comprises a (meth)acryl-based polymer.

The present invention also relates to an image display, comprising at least one piece of the pressure-sensitive adhesive optical film.

According to conventional technique, the front retardation value becomes larger at the window frame area than at the center area in a liquid crystal display using a pressure-sensitive adhesive optical film having a discotic liquid crystal layer functioning as an optical compensation layer, when a backlight is turned on for a long time, so that window frame unevenness occurs. In the pressure-sensitive adhesive optical film of the present invention, the pressure-sensitive adhesive layer is provided on the discotic liquid crystal layer with the undercoat layer containing a polymer and an antioxidant and being interposed therebetween, so that the undercoat layer can suppress window frame unevenness, which would otherwise be caused by an increase in front retardation at the window frame area.

Window frame unevenness tends to occur in a relatively large liquid display. Thus, the pressure-sensitive adhesive optical film of the present invention is particularly effective for large-sized pressure-sensitive adhesive optical films. Window frame unevenness also tends to occur at high environmental temperature. Thus, the pressure-sensitive adhesive optical film of the present invention is particularly effective for pressure-sensitive adhesive optical films for use in a high temperature environment.

The pressure-sensitive adhesive optical film of the present invention is suited for a case where the pressure-sensitive adhesive layer is made of an acrylic pressure-sensitive adhesive containing a (meth)acrylic polymer and a crosslinking agent, and a peroxide is used as the crosslinking agent. When a peroxide is used as the crosslinking agent for the pressure-sensitive adhesive, a small amount of the peroxide remaining in the pressure-sensitive adhesive layer or an acid or the like produced by the decomposition of the peroxide can affect the discotic liquid crystal layer to cause window frame unevenness. In the pressure-sensitive adhesive optical film of the present invention, however, the undercoat layer contains an antioxidant, which blocks the effect of the remaining peroxide, acid or the like on the discotic liquid crystal layer, so that window frame unevenness can be suppressed.

Moreover, even though the pressure-sensitive adhesive optical film of the invention has a discotic liquid crystal layer functioning as an optical compensation layer, it can suppress display unevenness in a peripheral portion of a display screen, since the pressure-sensitive adhesive layer placed on the discotic liquid crystal layer is formed using the specific (meth)acrylic polymer mixture as a base polymer of the pressure-sensitive adhesive. In the pressure-sensitive adhesive optical film of the invention, a mixture of the (meth)acrylic polymer (A) and the (meth)acrylic oligomer (B) is used as a base polymer of the pressure-sensitive adhesive layer forming a pressure-sensitive layer to suppress display unevenness in the peripheral portion. Therefore, as pressure-sensitive adhesives using an additive such as a plasticizer in addition to the base polymer, the pressure-sensitive adhesive of the invention does not cause precipitation of an additive itself so that defects in appearance or pressure-sensitive adhesive degradation can be prevented.

When the protective film layer has low moisture permeability in the pressure-sensitive adhesive optical film of the invention, peripheral unevenness can be more effectively suppressed, although the reason is not clear.

### BRIEF DESCRIPTION OF THE DRAWINGS

FIG. 1 is a cross-sectional view of an example of the pressure-sensitive adhesive optical film of the invention;

FIG. 2 is a cross-sectional view of another example of the pressure-sensitive adhesive optical film of the invention; and

FIG. 3 is a cross-sectional view of a further example of the pressure-sensitive adhesive optical film of the invention.

### DETAILED DESCRIPTION OF THE PREFERRED EMBODIMENTS

The present invention is described below with reference to the drawings.

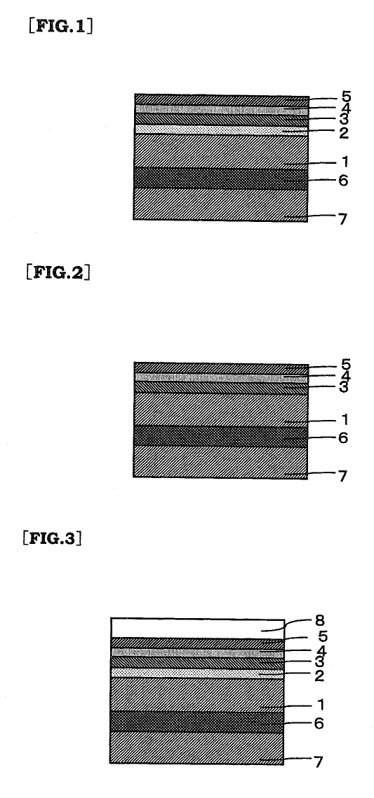

As shown in FIG. 1 to 3, the pressure-sensitive adhesive optical film of the present invention includes a transparent base film 1, a discotic liquid crystal layer 3 provided on one side of the base film 1, and a pressure-sensitive adhesive layer 5 provided on the discotic liquid crystal layer 3 with an undercoat layer 4 interposed therebetween. While FIG. 1 illustrates a case where an alignment film 2 is placed between the transparent base film 1 and the discotic liquid crystal layer 3, one side of the transparent base film 1 may be subjected to rubbing treatment, instead of providing the alignment film 2.

Various types of transparent materials may be used for the transparent base film. For example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming the base film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

In general, a thickness of the transparent base film, which can be determined arbitrarily, is 1 to 500 μm, especially 5 to 200 μm in viewpoint of strength, work handling and thin layer.

The transparent base film is preferably as colorless as possible. Thus, the transparent base is preferably used which has a film-thickness-direction retardation of −90nm to +75 nm, wherein the retardation (Rth) is represented by the formula: Rth=[(nx+ny)/(2−nz)]d, wherein nx and ny are each a principal refractive index in the plane of the film, nz is a refractive index in the film-thickness direction, and d is the thickness of the film. If the transparent base with such a thickness-direction retardation value (Rth) of −90 nm to +75 nm is used, coloring (optical coloring) of the polarizing plate can be almost avoided, which could otherwise be caused by any other transparent base film. The thickness-direction retardation (Rth) is more preferably from −80 nm to +60 nm, particularly preferably from −70 nm to +45 nm.

As the transparent base film, if polarization property and durability are taken into consideration, cellulose based polymer, such as triacetyl cellulose and norbornene based polymer, are preferable, and especially cellulose based polymer, such as triacetyl cellulose is suitable.

The discotic liquid crystal layer may be formed by aligning a discotic liquid crystal compound having a polymerizable unsaturated group and curing it. The discotic liquid crystal layer is useful as an optical compensation layer and can increase viewing angle, contrast, brightness, and the like. The discotic liquid crystal compound having a polymerizable unsaturated group can form a discotic liquid crystal layer, when the compound is aligned and cured. In a preferred mode, the discotic liquid crystal compound is obliquely aligned in the discotic liquid crystal layer. The thickness of the discotic liquid crystal layer is generally from about 0.5 to about 10 μm.

Discotic liquid crystal compounds have negative refractive index anisotropy (uniaxiality). Examples thereof include benzene derivatives as described in the research report by C. Destrade et al., Mol. Cryst. vol. 71, p. 111 (1981); cyclohexane derivatives as described in the research report by B. Kohne et al., Angew. Chem., vol. 96, p. 70 (1984); and azacrown or phenylacetylene type macrocyclic compounds as described in the research report by J. M. Lehn et al., J. Chem. Commun., p. 1794 (1985) and the research report by J. Zhang et al., J. Am. Chem. Soc., vol. 116, p. 2655 (1994). Discotic liquid crystal compounds may generally have a structure in which any of them forms a core at the center of the molecule and has radially provided straight substituents such as straight alkyl or alkoxy groups and substituted benzoyloxy groups. Discotic liquid crystal compounds include compounds that exhibit liquid crystal properties and are generally called “discotic liquid crystal.” It will be understood that discotic liquid crystal compounds are not limited to the above and include any molecule that has negative uniaxiality and can be oriented in a certain degree. In the present invention, the discotic liquid crystal compound may have a polymerizable unsaturated group, such as an acryloyl, methacryloyl, vinyl, or allyl group, and capable of causing a curing reaction by means of heat, light or the like. In the discotic liquid crystal layer, the final product is not necessarily the above-described compound and may include substances that have been polymerized or crosslinked by the reaction of the polymerizable unsaturated group and lost the liquid crystal properties by polymerization.

Discotic liquid crystal compounds encompasses not only various types of discotic liquid crystal compounds but also the whole of compounds whose molecule has optically-negative uniaxiality by itself, such as reaction products of discotic liquid crystals, which have already lost liquid crystal properties due to reaction with any other low-molecular-weight compound or polymer.

Alignment treatment of the discotic liquid crystal may be performed by rubbing the surface of the transparent base film or using an alignment film. Examples of the alignment film include obliquely vapor-deposited inorganic films and specific rubbed organic polymer films. Examples thereof also include thin films in which molecules are isomerized by light and uniformly arranged in a certain direction, such as LB films comprising azobenzene derivatives. Examples of organic alignment films include polyimide films and organic polymer films having a hydrophobic surface, such as alkyl chain-modified polyvinyl alcohol, polyvinyl butyral, or poly methylmethacrylate. Obliquely vapor-deposited inorganic films include obliquely vapor-deposited SiO films.

The discotic liquid crystal compound may be obliquely aligned. For example, a method that may be used for the alignment includes forming an alignment film on the transparent base film, then applying the discotic liquid crystal compound, which is polymerizable liquid crystal compound, thereto so that the compound is obliquely aligned, and then fixing the compound by application of light such as ultraviolet light or heat. Alternatively, the discotic liquid crystal may be obliquely aligned on any other alignment substrate and then transferred to the transparent support by the use of an optically-transparent adhesive or pressure-sensitive adhesive to form the discotic liquid crystal compound.

The discotic liquid crystal layers disclosed in Patent Literature (JP-A No. 08-95032 and JP-B No. 2767382) are preferably used. Wide View films manufactured by Fuji Photo Film Co., Ltd. have such an obliquely-aligned discotic liquid crystal layer formed on a cellulose polymer film.

The undercoat layer is made of an undercoating agent containing a polymer and an antioxidant. In a preferred mode, the polymer material shows good adhesion to both the pressure-sensitive adhesive layer and the discotic liquid crystal layer and can form a coating film with high cohesiveness.

Examples of the polymer include polyurethane resins, polyester resins, and polymers having an amino group in their molecule. The polymer to be used may be in any of a solvent-soluble form, a water-dispersible form and a water-soluble form. For example, water-soluble polyurethanes, water-soluble polyesters, water-soluble polyamides, and the like, and water-dispersible resins, such as ethylene-vinyl acetate copolymer emulsions and (meth)acrylic polymer emulsions, may be used. Water-dispersible types that may be used include emulsions produced by emulsifying various resins such as polyurethanes, polyesters and polyamides with an emulsifying agent; and self-emulsified products produced by introducing a water-dispersible hydrophilic anionic, cationic or nonionic group into any of the above resins. Ionic polymer complexes may also be used.

When the pressure-sensitive adhesive layer contains an isocyanate compound, the polymer preferably has a functional group reactive with the isocyanate compound. Such a polymer preferably has an amino group in its molecule. In particular, a polymer having a primary amino group at its end is preferably used. Such a polymer reacts with the isocyanate compound to produce strong adhesion. The polymer having a primary amino group at its end is preferably a poly (meth)acrylate having a primary amino end group.

Examples of the polymer having an amino group in its molecule include polyethyleneimines, polyallylamines, polyvinylamines, polyvinylpyridines, polyvinylpyrrolidines, and polymers of amino group-containing monomers such as dimethylaminoethyl acrylate. In particular, polyethyleneimines are preferred. Any type of polyethyleneimine material having a polyethyleneimine structure may be used, and examples thereof include polyethyleneimine and ethyleneimine adducts and/or polyethyleneimine adducts of polyacrylate. Particularly preferred are ethyleneimine adducts and/or polyethyleneimine adducts of polyacrylate, which are poly(meth)acrylates having a primary amino end group.

Various types of polyethyleneimine may be used without limitation. The weight average molecular weight of the polyethyleneimine is generally, but not limited to, from about 100 to about 1,000,000. Commercially available examples of the polyethyleneimine include Epomin SP series (such as SP-003, SP006, SP012, SP018, SP103, SP110, and SP200) and Epomin P-1000 manufactured by Nippon Shokubai Co., Ltd. Epomin P-1000 is particularly preferred.

Ethyleneimine adducts and/or polyethyleneimine adducts of polyacrylate may be obtained by emulsion polymerization of alkyl (meth)acrylate for forming a base polymer (acrylic polymer) of the acrylic pressure-sensitive adhesive described later and another monomer copolymerizable therewith in a conventional manner. The copolymerizable monomer to be used has a functional group such as a carboxyl group such that it can react with ethyleneimine or the like. The content of the monomer having such a functional group as carboxyl may be appropriately adjusted depending on the content of ethyleneimine or the like for the reaction. A styrene type monomer is preferably used as the copolymerizable monomer. The carboxyl group or the like in an acrylate may be allowed to react with a separately synthesized polyethyleneimine so that adducts grafted with polyethyleneimine can be produced. Commercially available examples thereof include Polyment NK-380 manufactured by Nippon Shokubai Co., Ltd.

Ethyleneimine adducts and/or polyethyleneimine adducts of acrylic polymer emulsions may also be used. Commercially available examples thereof include Polyment SK-1000 manufactured by Nippon Shokubai Co., Ltd.

Other examples of the polymer having a primary amino end group include products by a process including the steps of allowing excess diisocyanate to react with a carboxyl or hydroxyl group in polyacrylate and allowing excess diamine to react with it to introduce a primary amino end group. Poly(meth)acrylate having a primary amino end group may also be obtained by copolymerizing the (meth)acrylate with a monomer having a primary amino end group. Examples of the monomer having a primary amino end group include aminoethyl (meth)acrylate and aminopropyl (meth)acrylate.

Examples of the antioxidant contained in the undercoat layer include a phenolic antioxidant, a phosphorus antioxidant, a sulfur antioxidant, and an amine antioxidant, and at least one selected from these antioxidants may be used. In particular, a phenolic antioxidant is preferred.

Examples of the phenolic antioxidant include monocyclic phenol compounds such as 2,6-di-tert-butyl-p-cresol, 2,6-di-tert-butyl-4-ethylphenol, 2,6-dicyclohexyl-4-methylphenol, 2,6-diisopropyl-4-ethylphenol, 2,6-di-tert-amyl-4-methylphenol, 2,6-di-tert-octyl-4-n-propylphenol, 2,6-dicyclohexyl-4-n-octylphenol, 2-isopropyl-4-methyl-6-tert-butylphenol, 2-tert-butyl-4-ethyl-6-tert-octylphenol, 2-isobutyl-4-ethyl-6-tert-hexylphenol, 2-cyclohexyl-4-n-butyl-6-isopropylphenol, a mixed cresol modified with styrene, DL-α-tocopherol, and stearyl β-(3,5-di-tert-butyl-4-hydroxyphenyl)propionate; bicyclic phenol compounds such as 2,2′-methylenebis(4-methyl-6-tert-butylphenol), 4,4′-butylidenebis(3-methyl-6-tert-butylphenol), 4,4′-thiobis(3-methyl-6-tert-butylphenol), 2,2′-thiobis(4-methyl-6-tert-butylphenol), 4,4′-methylenebis(2,6-di-tert-butylphenol), 2,2′-methylenebis[6-(1-methylcyclohexyl)-p-cresol], 2,2′-ethylidenebis(4,6-di-tert-butylphenol), 2,2′-butylidenebis(2-tert-butyl-4-methylphenol), 3,6-dioxaoctamethylenebis[3-(3-tert-butyl-4-hydroxy-5-methylphenyl)propionate], triethyleneglycol bis[3-(3-tert-butyl-5-methyl-4-hydroxyphenyl)propionate], 1,6-hexanediol bis[3-(3,5-di-tert-butyl-4-hydroxyphenyl)propionate], and 2,2′-thiodiethylenebis[3-(3,5-di-tert-butyl-4-hydroxyphenyl)propionate]; tricyclic phenol compounds such as 1,1,3-tris(2-methyl-4-hydroxy-5-tert-butylphenyl)butane, 1,3,5-tris(2,6-dimethyl-3-hydroxy-4-tert-butylbenzyl)isocyanurate, 1,3,5-tris[(3,5-di-tert-butyl-4-hydroxyphenyl)propionyloxyethyl]isocyanurate, tris(4-tert-butyl-2,6-dimethyl-3-hydroxybenzyl)isocyanurate, and 1,3,5-trimethyl-2,4,6-tris(3,5-di-tert-butyl-4-hydroxybenzyl)benzene; tetracyclic phenol compounds such as tetrakis[methylene-3-(3,5-di-tert-butyl-4-hydroxyphenyl)propionate]methane; and phosphorus-containing phenol compounds such as potassium bis(ethyl 3,5-di-tert-butyl-4-hydroxybenzylphosphonate) and nickel bis(ethyl 3,5-di-tert-butyl-4-hydroxybenzylphosphonate).

Examples of the phosphorus antioxidant include trioctyl phosphite, trilauryl phosphite, tristridecyl phosphite, trisisodecyl phosphite, phenyl diisooctyl phosphite, phenyl diisodecyl phosphite, phenyl di(tridecyl) phosphite, diphenyl isooctyl phosphite, diphenyl isodecyl phosphite, diphenyl tridecyl phosphite, triphenyl phosphite, tris(nonylphenyl) phosphite, tris(2,4-di-tert-butylphenyl) phosphite, tris(butoxyethyl) phosphite, tetramidecyl-4,4′-butylidenebis(3-methyl-6-tert-butylphenol) diphosphite, 4,4′-isopropylidene-diphenol alkyl phosphite (wherein the alkyl group has about 12 to about 15 carbon atoms), 4,4′-isopropylidenebis(2-tert-butylphenol) di(nonylphenyl) phosphite, tris(biphenyl) phosphite, tetra(tridecyl)-1,1,3-tris(2-methyl-5-tert-butyl-4-hydroxyphenyl)butane diphosphite, tris(3,5-di-tert-butyl-4-hydroxyphenyl) phosphite, hydrogenated 4,4′-isopropylidenediphenol polyphosphite, bis(octylphenyl) bis[4,4′-butylidenebis(3-methyl-6-tert-butylphenol)]1,6-hexanediol diphosphite, hexamidecyl-1,1,3-tris(2-methyl-4-hydroxy-5-tert-butylphenol) diphosphite, tris[4,4′-isopropylidenebis(2-tert-butylphenol)]phosphite, tris(1,3-distearoyloxyisopropyl) phosphite, 9,10-dihydro-9-phosphaphenanthrene-10-oxide, tetrakis(2,4-di-tert-butylphenyl)-4,4′-biphenylene diphosphonite, distearyl pentaerythritol diphosphite, di(nonylphenyl)pentraerythritol diphosphite, phenyl 4,4,′-isopropylidenediphenol pentaerythritol diphosphite, bis(2,4-di-tert-butylphenyl)pentaerytritol diphosphite, bis(2,6-di-tert-butyl-4-methylphenyl)pentaerythritol diphosphite, and phenylbisphenol-A-pentaerythritol diphosphite.

Dialkyl thiodipropionates and polyhydric alcohol esters of alkylthiopropionic acid are preferably used as sulfur antioxidants. Dialkyl thiodipropionates having an alkyl group of 6 to 20 carbon atoms are preferably used in the present invention. Polyhydric alcohol esters of alkylthiopropionic acid preferably have an alkyl group of 4 to 20 carbon atoms. In this case, examples of the polyhydric alcohol for forming the polyhydric alcohol esters include glycerol, trimethylolethane, trimethylolpropane, pentaerythritol, and trishydroxyethyl isocyanurate. Examples of such dialkyl thiodipropionates include dilauryl thiodipropionate, dimyristyl thiodipropionate and distearyl thiodipropionate. Examples of polyhydric alcohol esters of alkylthiopropionic acid include glycerol tributylthiopropionate, glycerol trioctylthiopropionate, glycerol trilaurylthiopropionate, glycerol tristearylthiopropionate, trimethylolethane tributylthiopropionate, trimethylolethane trioctylthiopropionate, trimethylolethane trilaurylthiopropionate, trimethylolethane tristearylthiopropionate, pentaerythritol tetrabutylthiopropionate, pentaerythrtol tetraoctylthiopropionate, pentaerythritol tetralaurylthiopropionate, and pentaerythritol tetrastearylthiopropionate.

Examples of the amine antioxidant include bis(2,2,6,6-tetramethyl-4-piperidyl)sebacate, polycondensates of dimethyl succinate and 1-(2-hydroxyethyl)-4-hydroxy-2,2,6,6-tetramethylpiperidineethanol, N,N′,N″,N′″-tetrakis(4,6-bis(butyl-(N-methyl-2,2,6,6-tetramethylpiperidine-4-yl)amino)-triazine-2-yl)-4,7-diazadecane-1,10-diamine, polycondensates of dibutylamine-1,3,5-triazine-N,N′-bis(2,2,6,6-tetramethyl-4-piperidyl)-1,6-hexamethylenediamine and N-(2,2,6,6-tetramethyl-4-piperidyl)butylamine, poly[{6-1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], tetrakis(2,2,6,6-tetramethyl-4-piperidyl)-1,2,3,4-butanetetracarboxylate, 2,2,6,6-tetramethyl-4-piperidyl benzoate, bis(1,2,6,6-pentamethyl-4-piperidyl)-2-(3,5-di-tert-butyl-4-hydroxybenzyl)-2-n-butyl malonate, bis(N-methyl-2,2,6,6-tetramethyl-4-piperidyl)sebacate, 1,1′-(1,2-ethanediyl)-bis(3,3,5,5-tetramethylpiperadinone), (mixed 2,2,6,6-tetramethyl-4-piperidyl/tridecyl)-1,2,3,4-butanetetracarboxylate, (mixed 1,2,2,6,6-pentamethyl-4-piperidyl/tridecyl)-1,2,3,4-butanetetracarboxylate, mixed [2,2,6,6-tetramethyl-4-piperidyl/β,β,β′,β′-tetramethyl-3,9-[2,4,8,10-tetraoxaspiro(5,5)undecane]diethyl]-1,2,3,4-butanetetracarboxylate, mixed [1,2,2,6,6-pentamethyl-4-piperidyl/β,β,β′,β′-tetramethyl-3,9-[2,4,8,10-tetraoxaspiro(5,5)undecane]diethyl]-1,2,3,4-butanetetracarboxylate, condensates of N,N′-bis(3-aminopropyl)ethylenediamine-2,4-bis[N-butyl-N-(1,2,2,6,6-pentamethyl-4-piperidyl)amino]-6-chloro-1,3,5-triazine, poly[6-N-morpholyl-1,3,5-triazine-2,4-diyl][(2,2,6,6-tetramethyl-4-piperidyl)imino]hexamethylene[(2,2,6,6-tetramethyl-4-piperidyl)imide], condensates of N,N′-bis(2,2,6,6-tetramethyl-4-piperidyl)hexamethylenediamine and 1,2-dibromoethane, and [N-(2,2,6,6-tetramethyl-4-piperidyl)-2-methyl-2-(2,2,6,6-tetramethyl-4-piperidyl)imino]propionamide.

The undercoat layer contains the polymer and the antioxidant, generally contains 0.01 to 1000 parts by weight of the antioxidant based on 100 parts by weight of the polymer. The used amount of the antioxidant is preferably from 0.1 to 500 parts by weight. When the used amount of the antioxidant is less than 0.01 parts by weight, window frame unevenness may be sufficiently suppressed in some cases. On the other hand, when the used amount of the antioxidant is more than 1000 parts by weight, it is not preferred in view of anchoring effect or appearance. The used amount of the antioxidant is more preferably 1 part by weight or more, even more preferably 10 parts by weight or more, still more preferably 50 parts by weight or more. On the other hand, the used amount of the antioxidant is more preferably 350 parts by weight or less, even more preferably 150 parts by weight or less, still more preferably 100 parts by weight or less.

In the process of forming the undercoat layer, a crosslinking agent may be added to the polymer. For example, a compound capable of reacting with an amino group-containing polymer may be mixed with it to crosslink it so that the strength of the undercoat layer can be increased. Examples of the compound capable of reacting with an amino group-containing polymer include epoxy compounds and the like.

The undercoat layer is formed on the discotic liquid crystal layer of the optical film. For example, the undercoat layer may be formed by applying a solution of an undercoating agent containing the polymer and the antioxidant by an application method such as a coating, dipping or spraying method and then drying the coating. The thickness of the undercoat layer is preferably in the range of about 10 to about 5000 nm, more preferably of 50 to 500 nm. If the undercoat layer is too thin, it cannot have properties as a bulk or cannot exhibit sufficient strength so that adequate adhesion cannot be achieved in some cases. If it is too thick, the optical properties can be degraded. The coating amount (solid volume) of the undercoat layer is preferably from 0.1 to 5 cubic centimeters per one square meter, more preferably from 0.1 to 1 cubic centimeter per one square meter, still more preferably from 0.1 to 0.5 cubic centimeters per one square meter.

Acrylic pressure-sensitive adhesives are generally used, because they are colorless and clear and can have good adhesion to liquid crystal cells and the like.

A pressure-sensitive adhesive layer of the present invention comprises a (meth)acrylic polymer (A) comprising 80 to 99.5% by weight of an alkyl (meth)acrylate monomer unit and 0.05 to 3% by weight of a hydroxyl group-containing monomer unit and having a weight average molecular weight of 1,000,000 to 2,500,000; a (meth)acrylic oligomer (B) comprising 80 to 99.9% by weight of an alkyl (meth)acrylate monomer unit and 0.1 to 3% by weight of a carboxyl group-containing monomer unit and having a weight average molecular weight of 3,000 to 8,000; a crosslinking agent (C); and a silane coupling agent (D), and the pressure-sensitive adhesive layer comprises 10 to 40 parts by weight of the (meth)acrylic oligomer (B) based on 100 parts by weight of the (meth)acrylic polymer (A).

The pressure-sensitive adhesive layer includes, as a base polymer, a mixture of a (meth)acrylic polymer (A) and a (meth)acrylic oligomer (B) each including a main skeleton of an alkyl (meth)acrylate monomer unit. As used herein, the term “(meth)acrylate” refers to acrylate and/or methacrylate, and “(meth)” is used herein in the same sense.

The (meth)acrylic polymer (A) of the invention includes 80 to 99.5% by weight of an alkyl (meth)acrylate monomer unit and 0.05 to 3% by weight of a hydroxyl group-containing monomer unit.

In the alkyl (meth)acrylate, the alkyl group has about 1 to about 18 carbon atoms, preferably 1 to 9 carbon atoms and may be any of a straight chain and a branched chain. Examples of the alkyl (meth)acrylate include such as methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, n-octyl (meth)acrylate, isooctyl (meth)acrylate, decyl (meth)acrylate, dodecyl (meth)acylate, lauryl (meth)acrylate, and stearyl (meth)acrylate. These (meth)acrylates may be used alone or in mixture of two or more kinds. The average number of carbon atoms in the alkyl group is preferably from 4 to 12.

In the (meth)acrylic polymer (A), the content of the alkyl (meth)acrylate monomer unit is from 80 to 99.5% by weight, preferably from 85 to 99.3% by weight, more preferably from 90 to 99% by weight. When only the hydroxyl group-containing monomer is copolymerized, the content of the alkyl (meth)acrylate monomer unit is preferably from 97 to 99.5% by weight, more preferably from 97.5 to 99.3% by weight.

Examples of the hydroxyl group-containing monomer include such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate. These monomers may be used alone or in mixture of two or more kinds.

In the (meth)acrylic polymer (A), the content of the hydroxyl group-containing monomer unit is from 0.05 to 3% by weight, preferably from 0.075 to 2.5% by weight, more preferably from 0.1 to 2% by weight. If the content is more than the above range, the crosslink density of the polymer can be too high so that the adhesive property may be reduced in some cases. In addition, the coatability may also be degraded. On the other hand, when the content is too low, the crosslink degree maynot be increased so that the durability may be low in some cases. The hydroxyl group-containing monomer can also form a crosslinking point with an isocyanate crosslinking agent and thus can contribute to an improvement in durability and other properties. Here, when only the hydroxyl group-containing monomer is copolymerized, the content of the hydroxyl group-containing monomer is preferably from 0.5 to 3% by weight, more preferably from 0.7 to 2.5% by weight.

Besides the alkyl (meth)acrylate component and the hydroxyl group-containing monomer component, the (meth)acrylic polymer (A) may further include an other monomer component.

Examples of the other monomer component include carboxyl group-containing monomers such as (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; and phosphate group-containing monomers such as 2-hydroxyethylacryloyl phosphate.

Examples of the other monomer component also include nitrogen-containing vinyl monomers. Examples of such monomers for the purpose of modification include maleimide; (N-substituted) amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, aminopropyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide.

Examples of the other monomer component also include vinyl monomers such as vinyl acetate, vinyl propionate, N-vinylcarboxylic acid amides, styrene, a-methylstyrene, and N-vinylcaprolactam; nitrile monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as fluoro(meth)acrylate, silicone (meth)acrylate, and 2-methoxyethyl acrylate.

The other monomer component may be used as appropriate in order to modify the (meth)acrylic polymer (A). One or more other monomer components may be used. The content of the other monomer component is preferably 10% by weight or less, more preferably 6% by weight or less, while it may be in such a range that the above ranges of the contents of the alkyl (meth)acrylate monomer unit and the hydroxyl group-containing monomer unit are satisfied. It is not preferred that the content of the other monomer component is more than 10% by weight, because the pressure-sensitive adhesive can possibly lose flexibility.

The other monomer component is preferably a carboxyl group-containing monomer, particularly acrylic acid, from a viewpoint of good adhesive property. When the carboxyl group-containing monomer unit is used, the content thereof may be from about 0.1 to about 10% by weight, preferably from 0.5 to 8% by weight, more preferably from 1 to 6% by weight.

The weight average molecular weight of the (meth)acrylic polymer (A) used in the invention is from 1,000,000 to 2,500,000, preferably from 1,200,000 to 2,400,000, more preferably from 1,500,000 to 2,200,000. The (meth)acrylic polymer (A) may be produced by a variety of known methods, for example, by a method appropriately selected from radical polymerization methods such as a bulk polymerization method, a solution polymerization method and a suspension polymerization method. A variety of known radical polymerization initiators may be used such as azo-based initiators and peroxide-based initiators. The reaction is generally performed at a temperature of about 50 to about 80° C. for a time period of 1 to 8 hours. In addition, among the above production methods, the solution polymerization method is preferred, in which ethyl acetate, toluene or the like is generally used as a solvent for the (meth)acrylic polymer (A). The concentration of the solution is generally from about 20 to about 80% by weight. The weight average molecular weight of the (meth)acrylic polymer (A) was measured by gel permeation chromatography (GPC) under the following conditions: analyzer, HLC-8120GPC manufactured by Tosoh Corporation; column, G7000HXL+GMHXL+GMHXL manufactured by Tosoh Corporation; column size, each 7.8 mmφ×30 cm, 90 cm in total; column temperature, 40° C.; flow rate, 0.8 ml/minute; injection volume, 100 μl; eluent, tetrahydrofuran; detector, differential refractometer; standard sample, polystyrene.

The (meth)acrylic oligomer (B) of the invention includes 80 to 99.9% by weight of an alkyl (meth)acrylate monomer unit and 0.1 to 3% by weight of a carboxyl group-containing monomer unit.

In the alkyl (meth)acrylate, the alkyl group may have about 1 to about 18 carbon atoms, preferably 1 to 9 carbon atoms and may be any of a straight chain and a branched chain. Examples of the alkyl (meth)acrylate include such as methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, n-octyl (meth)acrylate, isooctyl (meth)acrylate, decyl (meth)acrylate, dodecyl (meth)acylate, lauryl (meth)acrylate, and stearyl (meth)acrylate. These (meth)acrylates may be used alone or in mixture of two or more kinds. The average number of carbon atoms in the alkyl group is preferably from 4 to 12.

In the (meth)acrylic oligomer (B), the content of the alkyl (meth)acrylate monomer unit is from 80 to 99.9% by weight, preferably from 85 to 99.3% by weight, more preferably from 90 to 99% by weight. When only the carboxyl group-containing monomer is copolymerized, the content of the alkyl (meth)acrylate monomer unit is preferably from 97 to 99.9% by weight, more preferably from 97.5 to 99.5% by weight, more preferably from 97.8 to 99.25% by weight.

Examples of the carboxyl group-containing monomer include such as (meth)acrylic acid, carboxyethyl (meth)acrylate, carboxypentyl (meth)acrylate, itaconic acid, maleic acid, fumaric acid, and crotonic acid, and maleic anhydride and itaconic anhydride. These monomers may be used alone or in mixture of two or more kinds.

In the (meth)acrylic oligomer (B), the content of the carboxyl group-containing monomer unit is from 0.1 to 3% by weight, preferably from 0.5 to 2.5% by weight, more preferably from 0.75 to 2.2% by weight. If the content of the carboxyl group-containing monomer unit is less than the above range, hydrogen bonds do not work between the oligomers so that bleeding may occur in some cases. On the other hand, when the content is more than the above range, the storage stability may be reduced in some cases. Here, when only the carboxyl group-containing monomer is copolymerized, the content of the carboxyl group-containing monomer unit is preferably in the range described above.

Besides the alkyl (meth)acrylate component and the carboxyl group-containing monomer component, the (meth)acrylic oligomer (B) may further include an other monomer component.

Examples of the other monomer component include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; and phosphate group-containing monomers such as 2-hydroxyethylacryloyl phosphate.

Examples of the other monomer component also include nitrogen-containing vinyl monomers. Examples of such monomers for the purpose of modification include maleimide; (N-substituted) amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, aminopropyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide.

Examples of the other monomer component also include vinyl monomers such as vinyl acetate, vinyl propionate, N-vinylcarboxylic acid amides, styrene, a-methylstyrene, and N-vinylcaprolactam; nitrile monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as fluoro(meth)acrylate, silicone (meth)acrylate, and 2-methoxyethyl acrylate.

The other monomer component may be used as appropriate in order to modify the (meth)acrylic oligomer (B). One or more other monomer components may be used. The content of the additional monomer component unit is preferably 10% by weight or less, more preferably 6% by weight or less, while it may be in such a range that the above ranges of the contents of the alkyl (meth)acrylate monomer unit and the carboxyl group-containing monomer unit are satisfied. It is not preferred that the content of the additional monomer component unit is more than 10% by weight, because the pressure-sensitive adhesive can possibly lose flexibility.

The weight average molecular weight of the (meth)acrylic oligomer (B) used in the invention is from 3,000 to 8,000, preferably from 3,500 to 7,000, more preferably from 4,000 to 6,500. The (meth)acrylic oligomer (B) may be produced by a variety of known methods, for example, by a method appropriately selected from radical polymerization methods such as a bulk polymerization method, a solution polymerization method and a suspension polymerization method. A variety of known radical polymerization initiators may be used such as azo-based initiators and peroxide-based initiators. The reaction is generally performed at a temperature of about 50 to about 80° C. for a time period of 1 to 8 hours. In addition, among the above production methods, the solution polymerization method is preferred, in which ethyl acetate, toluene or the like is generally used as a solvent for the (meth)acrylic oligomer (B). The concentration of the solution is generally from about 20 to about 80% by weight. The weight average molecular weight of the (meth)acrylic oligomer (B) was measured by gel permeation chromatography (GPC) according to the same way of (meth)acrylic polumer (A).

The pressure-sensitive adhesive layer includes 10 to 40 parts by weight, preferably 15 to 35 parts by weight, more preferably 20 to 33 parts by weight of the (meth)acrylic oligomer (B) based on 100 parts by weight of the (meth)acrylic polymer (A). When the amount of the (meth)acrylic oligomer (B) is less than 10 parts by weight, peripheral unevenness may not be suppressed in some cases. On the other hand, when the amount of the (meth)acrylic oligomer (B) is more than 40 parts by weight, storage stability may be degraded in some cases.

The pressure-sensitive adhesive for forming the pressure-sensitive adhesive layer according to the present invention include a crosslinking agent in addition to the base polymer.

The crosslinking agent (C) can improve adhesion to the optical film and durability and can achieve high temperature reliability or preserve the shape of the pressure-sensitive adhesive itself at high temperature. Any appropriate crosslinking agent may be used, such as an isocyanate type, epoxy type, peroxide type, metal chelate type, or oxazoline type crosslinking agent. One or more of these crosslinking agents may be used alone or in any combination. The present invention is preferably applied to the case where the peroxide is contained as the crosslinking agent. Besides the peroxide crosslinking agent, the isocyanate crosslinking agent is also preferred.

Various types of peroxides may be used as the peroxide crosslinking agent. Examples of such peroxides include di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutyl peroxyisobutylate, 1,1,3,3-tetramethylbutylperoxy-2-ethyl hexanoate, di(4-methylbenzoyl) peroxide, dibenzoyl peroxide, and tert-butylperoxyisobutylate. Above all, di(4-tert-butylcyclohexyl)peroxydicarbonate, dilauroyl peroxide and dibenzoyl peroxide are preferably used, because their crosslinking reaction efficiency is particularly good.

Isocyanate compounds may be used as isocyanate crosslinking agents. Examples of the isocyanate compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyanate, and adduct type isocyanate compounds produced by adding the isocyanate monomer to trimethylolpropane or the like; and isocyanurate compounds, burette type compounds, and urehthane prepolymer type isocyanates produced by addition reaction of or known polyether polyols, polyester polyols, acrylic polyols, polybutadiene polyols, polyisoprene polyols, or the like.

Examples of the epoxy crosslinking agent include bisphenol A-epichlorohydrin type epoxy resins. Examples of the epoxy crosslinking agent also include ethylene glycol diglycidyl ether, polyethylene glycol diglycidyl ether, glycerol diglycidyl ether, glycerol triglycidyl ether, 1,6-hexanediol diglycidyl ether, trimethylolpropane triglycidyl ether, diglycidylaniline, N,N,N′,N′-tetraglycidyl-m-xylylenediamine, 1,3-bis(N,N-diglycidylaminomethyl)cyclohexane, N,N,N′,N′-tetraglycidylaminophenylmethane, triglycidylisocyanurate, m-N,N-diglycidylaminophenyl glycidyl ether, N,N-diglycidyltoluidine, and N,N-diglycidylaniline.

The crosslinking agent may be used in an amount of 10 parts by weight or less, preferably of 0.01 to 5 parts by weight, more preferably of 0.02 to 3 parts by weight, based on 100 parts by weight of the (meth)acrylic polymer (A). The use of more than 10 parts by weight of the crosslinking agent can provide excessive crosslinkage to reduce the adhesion and is not preferred.

Particularly when the peroxide is used as the crosslinking agent, the amount of the peroxide is preferably about 0.05 to about 1 part by weight, more preferably from 0.06 to 0.5 parts by weight, based on 100 parts by weight of the (meth)acrylic polymer (A). It should be noted that when a certain peroxide is used as a polymerization initiator for the (meth)acrylic polymer (A) and remains in the (meth)acrylic polymer (A), the amount of the peroxide residue should be included in the amount of the blended peroxides. When the isocyanate crosslinking agent is used in combination with the peroxide, the content of the isocyanate crosslinking agent is preferably about 0.01 to about 1.5 parts by weight, more preferably 0.02 to 1 part by weight.

The pressure-sensitive adhesive for forming the pressure-sensitive adhesive layer according to the present invention also includes a silane coupling agent (D) in addition to the base polymer.

Examples of the silane coupling agent include, specifically, epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-2-(aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane. Such a silane coupling agent is preferably used to improve the durability.

The silane coupling agents may be used alone or in mixture of two or more kinds. The total content of the silane coupling agent is preferably from 0.01 to 1 part by weight, more preferably from 0.02 to 0.6 parts by weight, even more preferably from 0.05 to 0.3 parts by weight, based on 100 parts by weight of the (meth)acrylic polymer (A). The use of the silane coupling agent at content in the above range allows a more reliable improvement in a cohesive strength or durability. On the one hand, when the content is less than 0.01 parts by weight, durability can be reduced in some cases. On the other hand, when the content is more than 1 part by weight, adhering strength to an optical member such as a liquid crystal cell can be excessive in some cases.

If necessary, the pressure-sensitive adhesive may conveniently contain various types of additives such as tackifiers, plasticizers, fillers comprising glass fibers, glass beads, metal power, or any other inorganic powder, pigments, colorants, fillers, antioxidants, and ultraviolet absorbing agents without departing from the object of the present invention. The pressure-sensitive adhesive layer may also contain fine particles so as to have light diffusion properties.

The pressure-sensitive adhesive layer may be formed by lamination on the undercoat layer. Examples of the forming method include, but are not limited to, methods of applying and drying a pressure-sensitive adhesive (solution) and methods of transferring the pressure-sensitive adhesive layer from a release sheet. Methods of application that may be used include roll coating methods such as reverse coating and gravure coating and other coating methods such as spin coating methods, screen coating methods, fountain coating methods, dipping methods, and spray methods.

If the pressure-sensitive adhesive layer is too thin in the pressure-sensitive adhesive optical film of the present invention, window frame unevenness can tend to occur. In the pressure-sensitive adhesive optical film of the present invention, therefore, the pressure-sensitive adhesive layer preferably has a thickness of 5 to 40 μm, more preferably a relatively small thickness of 5 to 25 μm. In addition, if the pressure-sensitive adhesive layer is relatively hard in the pressure-sensitive adhesive optical film of the present invention, window frame unevenness can tend to occur.

Examples of constituent materials of a release sheet include: proper thin items such as paper; synthetic resin films made of polyethylene, polypropylene, polyethylene terephthalate; a rubber sheet, paper, cloth, unwoven fabric, net, a foam sheet and a metal foil, and a laminate thereof. In order to enhance releasability from a pressure-sensitive adhesive layer, a release treatment imparting a low adherence, such as a silicone treatment, a long chain alkylation treatment or a fluorination treatment, may be applied onto a surface of a release sheet when required.

In order to impart antistatic properties to the pressure-sensitive adhesive optical film, an antistatic agent may also be used. The antistatic agent may be added to each layer, or alternatively, an antistatic layer may be independently formed. Examples of the antistatic agent include ionic surfactants; electrically-conductive polymers such as polyaniline, polythiophene, polypyrrole, and polyquinoxaline; and metal oxides such as tin oxide, antimony oxide and indium oxide. In particular, electrically-conductive polymers are preferably used, in view of optical properties, appearance, antistatic effect, and stability of the antistatic effect during heating or humidifying. In particular, a water-soluble or dispersible electrically-conductive polymer such as polyaniline and polythiophene is preferably used, because when the water-soluble or dispersible electrically-conductive polymer is used as an antistatic layer-forming material in the coating process, the optical film substrate can be prevented from deteriorating due to an organic solvent.

In the invention, the optical film further includes a protective film layer that is laminated on one side of the transparent base film with the polarizer interposed therebetween, wherein the side is not provided with the discotic liquid crystal layer.

The protective film layer preferably has low moisture permeability. Specifically, the protective film layer preferably has a water-vapor permeability of 200 g/m² per 24 hours or less at 40° C. and 90% R.H., more preferably 150 g/m² per 24 hours or less at 40° C. and 90% R.H., even more preferably 100 g/m² per 24 hours or less at 40° C. and 90% R.H.

Examples of materials that may be used to form the protective film layer with low moisture permeability include polycarbonate-based polymers; arylate-based polymers; polyester-based polymers such as polyethylene terephthalate and polyethylene naphthalate; amide-based polymers such as nylons and aromatic polyamides; polyolefin polymers such as polyethylene, polypropylene and ethylene-propylene copolymers; cyclic olefin-based resins having a cyclic structure or a norbornene structure; and any mixture thereof.

The protective film layer is also preferably made of a (meth)acryl-based polymer.

As shown in FIG. 1 to 3, the optical film according to the present invention may include, and a polarizer 6 and a transparent protective film 7 that are laminated in this order on one side of a transparent base film 1 where the discotic liquid crystal layer 3 is not formed.

The polarizer 6 may be bonded to the transparent base film 1 with an adhesive. A polarizing plate including a polarizer and a transparent protective film laminated on one or both sides of the polarizer may be laminated on the transparent base film 1.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blockdng inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As a materials forming the transparent protective film prepared on one side or both sides of the above-mentioned polarizer, with outstanding transparency, mechanical strength, heat stability, moisture cover property, isotropy, etc. may be preferable. The transparent protective film may be made of the same material as the transparent base film and may have the same thickness as the transparent base film.

The transparent base film and the transparent protective film may use the same or different polymer materials.

The polarizer, the transparent base film and the transparent protective film are generally bonded together with a water-based adhesive or the like interposed therebetween. Examples of the water-based adhesive include isocyanate adhesives, polyvinyl alcohol adhesives, gelatin adhesives, vinyl adhesives, latex adhesives, aqueous polyurethane adhesives, and aqueous polyester adhesives. Before the polarizer, the transparent base film and the transparent protective film are bonded together, the transparent base film and the transparent protective film may be subjected to activation treatment. Various methods such as saponification, corona treatment, low-pressure UV treatment, and plasma treatment may be used for the activation treatment. When the transparent base film is made of triacetylcellulose, norbornene resin, polycarbonate, or polyolefin resin, the activation treatment is particularly effective.

As the opposite side of the polarizing-adhering surface above-mentioned transparent protective film, a film with a hard coat layer and various processing aiming for antireflection, sticking prevention and diffusion or anti glare may be used.

A hard coat processing is applied for the purpose of protecting the surface of the polarization plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarization plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarization plate to disturb visual recognition of transmitting light through the polarization plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarization plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film.

Besides the optical film including the polarizing plate laminated, as an optical film used for the pressure-sensitive adhesive optical film of the present invention, optical layers used for forming image displays such as liquid crystal display or the like, are used. For example, optical layers, such as a reflective plate, a transflective plate, a retardation plate (a half wavelength plate and a quarter wavelength plate included), and a viewing angle compensation film, which may be used for formation of a liquid crystal display or the likes are mentioned. These are used in practice as an optical film, or as one layer or two layers or more of optical layers laminated with polarizing plate.

Especially preferable polarizing plates are; a reflection type polarization plate or a transflective type polarization plate in which a reflective plate or a transflective reflective plate is further laminated onto a polarizing plate of the present invention; an elliptically polarizing plate or a circular polarizing plate in which a retardation plate is further laminated onto the polarizing plate; or a polarizing plate in which a brightness enhancement film is further laminated onto the polarizing plate.

A reflective layer is prepared on a polarization plate to give a reflection type polarization plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarization plate may be formed using suitable methods, such as a method in which a reflective layer of metal etc. is, if required, attached to one side of a polarization plate through a transparent protective layer etc.

As an example of a reflection type polarization plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarization plate, a reflection plate may also be used as a reflective sheet constituted by preparing a reflective layer on the suitable film for the transparent film. In addition, since a reflective layer is usually made of metal, it is desirable that the reflective side is covered with a protective film or a polarization plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarization plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarization plate. That is, the transflective type polarization plate is useful to obtain of a liquid crystal display of the type that saves energy of light sources, such as a back light, in a well-lighted atmosphere, and can be used with a built-in light source if needed in a comparatively dark atmosphere etc.

A description of the above-mentioned elliptically polarization plate or circularly polarization plate on which the retardation plate is laminated to the polarization plates will be made in the following paragraph. These polarization plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarization plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarization plate in which three-dimensional refractive index is controlled may also preferably compensate (prevent) coloring produced when a screen of a liquid crystal display is viewed from an oblique direction. Circularly polarization plate is effectively used, for example, when adjusting a color tone of a picture of a reflection type liquid crystal display that provides a colored picture, and it also has function of antireflection.

As retardation plates, birefringence films obtained by uniaxial or biaxial stretching polymer materials, oriented films of liquid crystal polymers, and materials in which orientated layers of liquid crystal polymers are supported with films may be mentioned. Although a thickness of a retardation plate also is not especially limited, it is in general approximately from about 20 to 150 μm.

As polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyallyl sulfones, polyvinyl alcohols, polyamides, polyimides, polyolefins, polyvinyl chlorides, cellulose type polymers, or bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystalline polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarization plate and an above-mentioned reflected type elliptically polarization plate are laminated plate combining suitably a polarization plate or a reflection type polarization plate with a retardation plate. This type of elliptically polarization plate etc. may be manufactured by combining a polarization plate (reflected type) and a retardation plate, and by laminating them one by one separately in the manufacture process of a liquid crystal display. On the other hand, the polarization plate in which lamination was beforehand carried out and was obtained as an optical film, such as an elliptically polarization plate, is excellent in a stable quality, a workability in lamination etc., and has an advantage in improved manufacturing efficiency of a liquid crystal display.

The polarization plate with which a polarization plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarization plate, which is obtained by laminating a brightness enhancement film to a polarization plate, thus does not transmit light without the predetermined polarization state and reflects it, while obtaining transmitted light with the predetermined polarization state by accepting a light from light sources, such as a backlight. This polarization plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarization plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarization plate as it is, the absorption loss by the polarization plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarization plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarization plate may consist of multi-layered film of laminated layers of a polarization plate and two of more of optical layers as the above-mentioned separated type polarization plate. Therefore, a polarization plate may be a reflection type elliptically polarization plate or a semi-transmission type elliptically polarization plate, etc. in which the above-mentioned reflection type polarization plate or a transfiective type polarization plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In addition, ultraviolet absorbing property may be given to the above-mentioned each layer of the optical film, and the adhesive layer etc., of the pressure-sensitive adhesive optical film of the present invention, using a method of adding UV absorbents, such as salicylic acid ester type compounds, benzophenol type compounds, benzotriazol type compounds, cyano acrylate type compounds, and nickel complex salt type compounds.

The pressure-sensitive adhesive optical film of the present invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other components such as a lighting system and incorporating a driving circuit according to any conventional technique, except that the optical film of the present invention is used. Any type of liquid crystal cell may also be used such as a TN type, an STN type and a n type.

Suitable liquid crystal displays, such as liquid crystal display with which the above pressure-sensitive adhesive optical film has been located at one side or both sides of the liquid crystal cell, and with which a backlight or a reflective plate is used for a lighting system may be manufactured. In this case, the optical film may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg-Ag and Al-Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

The present invention is more specifically described with some examples below which are not intended to limit the scope of the present invention. In each example, “part,” “parts” and “%” are all by weight.

### Example 1

### Preparation of (Meth)Acrylic Polymer (A)

To a four-neck flask equipped with a stirring blade, a thermometer, a nitrogen gas introducing tube, and a condenser were added 99 parts by weight of butyl acrylate (BA), 1 part by weight of 4-hydroxybutyl acrylate (HBA), 0.1 part by weight of 2,2′-azobisisobutyronitrile as a polymerization initiator, and 200 parts by weight of ethyl acetate. Nitrogen gas was introduced to sufficiently replace the air, while the mixture was gently stirred, and then a polymerization reaction was performed for 8 hours, while the temperature of the liquid in the flask was kept at about 55° C., so that a solution of an acrylic polymer (named acrylic polymer (I)) was prepared. The acrylic polymer (I) had a weight average molecular weight of 1,800,000.

### Preparation of (Meth)Acrylic Oligomer (B)

To a four-neck flask equipped with a stirring blade, a thermometer, a nitrogen gas introducing tube, and a condenser were added 99 parts by weight of butyl acrylate (BA), 2 parts by weight of acrylic acid (AA), 3 parts by weight of 2-mercaptoethanol, 0.1 part by weight of 2,2′-azobisisobutyronitrile as a polymerization initiator, and 140 parts by weight of toluene. Nitrogen gas was introduced to sufficiently replace the air, while the mixture was gently stirred, and then a polymerization reaction was performed for 8 hours, while the temperature of the liquid in the flask was kept at about 70° C., so that a solution of an acrylic oligomer (named acrylic oligomer (a)) was prepared. The acrylic oligomer (a) had a weight average molecular weight of 4,500.

(Preparation of Polarizing Plate with Undercoat Layer)

An 80 μm-thick Arton film (with a water-vapor permeability of 100 g/m² per 24 hours at 40° C. and 90% R.H., manufactured by JSR Co., Ltd.) was bonded to one side of a 20 μm-thick polarizer. A discotic liquid crystal layer was formed on one side of an 80 μm-thick triacetylcellulose film, and the triacetylcellulose film side of the resulting laminate was bonded to the other side of the polarizer so that a polarizing film with an optical compensation layer was prepared.

Polyment NK-380 (manufactured by Nippon Shokubai Co., Ltd.) was then diluted with toluene to a solids content of 0.2% by weight. To the resulting solution was added 100 parts by weight of a phenolic antioxidant (IRGANOX 1010 manufactured by Ciba Specialty Chemicals Co., Ltd.) based on 100 parts by weight of the NK-380 to prepare a coating solution. The coating solution was applied with a bar coater to the discotic liquid crystal layer side of the polarizing film with an optical compensation layer and dried to produce an anchor coat layer with a coating amount of 0.2 cubic centimeters.

### (Preparation of Pressure-Sensitive Adhesive Composition)

30 parts by weight of the acrylic oligomer (a), 0.1 part by weight of a silane coupling agent of 3-glycidoxypropyltrimethoxysilane (KBM403 manufactured by Shin-Etsu Chemical Co., Ltd.) and 0.1 part by weight of a crosslinking agent of a trimethylolpropane/tolylene diisocyanate trimer adduct (Coronate L, manufactured by Nippon Polyurethane Industry Co., Ltd.) based on 100 parts by weight of the solids of the acrylic polymer (1) solution were uniformly mixed and stirred so that an acrylic pressure-sensitive adhesive solution (1) was prepared.

### (Preparation of Pressure-Sensitive Adhesive-Type Polarizing Plate)

The acrylic pressure-sensitive adhesive solution (1) was then applied to one side of a silicone-treated polyethylene terephthalate (PET) film (38 wn in thickness, manufactured by Toray Industries, Inc.) and dried at 155° C. for 3 minutes to form a pressure-sensitive adhesive layer that has a thickness of 20 μm after the drying.

The pressure-sensitive adhesive layer was bonded to the surface of the undercoat layer of the polarizing film with an optical compensation layer to produce a pressure-sensitive adhesive optical film.

### Examples 2 to 6 and Comparative Examples 1 to 9

In Example 1, pressure-sensitive adhesive optical films were prepared using the process of Example 1, except that: the type or blending amount of the monomer components for use in preparing the pressure-sensitive adhesive (the (meth)acrylic polymer (A) and the (meth)acrylic oligomer (B)) was changed as shown in Table 1; the presence or absence of the phenolic antioxidant in the preparation of the undercoat agent was changed as shown in Table 1; and the type of the protective film was changed as shown in Table 1.

In Comparative Example 5, the undercoat layer contained no antioxidant, while the pressure-sensitive adhesive layer contained 1 part by weight of the antioxidant (IRGANOX 1010 manufactured by Ciba Specialty Chemicals Co., Ltd.) based on 100 parts by weight of the pressure-sensitive adhesive polymer (the acrylic polymer). Comparative Example 9 was a case where neither the undercoat layer nor the pressure-sensitive adhesive layer contained the antioxidant.

Zeonor was a product manufactured by Zeon Corporation having a water-vapor permeability of 10 g/m² per 24 hours at 40° C. and 90% R.H. TAC was a product manufactured by Fuji Photo Film Co., Ltd. having a water-vapor permeability of 800 g/m² per 24 hours at 40° C. and 90% R.H.

### (Evaluation of Moisture Absorption Characteristics)

The moisture absorption characteristics of the protective film were evaluated according to JIS Z 0208 as described below. A sample was attached to a calcium chloride-containing test cup, and the periphery was completely sealed with sealing wax. The sample was allowed to absorb moisture under the conditions of 40° C. and 90% R.H. for a certain period of time. When the increased weight became constant, the weight of the permeated water vapor per 24 hours was determined from the average weight increase. The water-vapor permeability was calculated based on the result.

The resulting pressure-sensitive adhesive optical films were evaluated as described below. The results are shown in Table 1.

### (Peripheral Unevenness)

Two sample pieces (420 mm in length×320 mm in width) were prepared by cutting each pressure-sensitive adhesive optical film. The pressure-sensitive adhesive optical film samples were bonded with a laminator to both sides of a 0.07 mm-thick non-alkali glass plate in the crossed Nicol arrangement. The sample was then subjected to autoclave treatment at 50° C. under 5 atm for 15 minutes. The sample was then treated for 500 hours under each of the condition of 100° C. (heating) and the condition of 90% R.H. (humidifying) at 60° C. The sample was then placed on a 10,000 candela backlight, and light leakage was visually evaluated according to the criteria below.

⊙: There was neither peripheral unevenness nor practical problem.
◯: Peripheral unevenness was slightly observed, but there was no practical problem.
Δ: Peripheral unevenness was observed, but there was no practical problem.
x: Peripheral unevenness was significantly observed to cause a practical problem.

### (Window Frame Unevenness)

The resulting pressure-sensitive adhesive optical film sample (300 mm×220 mm in size) was bonded to a test glass substrate using a roller. The test glass substrate used was a non-alkali glass plate (0.7 mm in thickness, 350 mm×250 mm in size). After the bonding, the sample was placed in an autoclave (50° C., 5 atm×15 minutes). Thereafter, a window frame test was performed. In the window frame test, a backlight was tuned on in an atmosphere at 80° C., and the sample was placed on the backlight. Whether window frame unevenness was generated in the peripheral portion of the optical film (within 10 mm from the edge) or not was visually evaluated according to the criteria below. The observation was performed after a lighting time of 0, 120 or 240 hours.

⊙: There is no unevenness in the peripheral portion.
◯: Unevenness in the peripheral portion is slightly observed in a dark place.
x: Unevenness in the peripheral portion is clearly observed in a dark place.
xx: Unevenness in the peripheral portion is observed in a bright place.

### (Durability)

The pressure-sensitive adhesive optical film (15 inches in size) was bonded to a non-alkali glass plate (Corning 1737 with a thickness of 0.7 mm) and subjected to treatment in an autoclave at 50° C. under 0.5 MPa for 15 minutes. The sample was then treated for 500 hours under each of the condition of 90° C. (heating) and the condition of 95% R.H. (humidifying) at 60° C. The sample was then visually evaluated according to the criteria below.

⊙: Neither separation, peeling off nor foaming occurred between the pressure-sensitive adhesive optical film and the non-alkali glass plate.
◯: Peeling off was slightly (200 μm or less) occurred at an edge portion, but there was no practical problem.
x: Separation, peeling off or foaming occurred between the pressure-sensitive adhesive optical film and the non-alkali glass plate to cause a practical problem.

TABLE 1

| | Pressure-Sensitive Adhesive Composition | | | | | | |
|---|---|---|---|---|---|---|---|
| | | | (meth)acrylic Oligomer (B) | | | | |
| | (meth)acrylic Polymer (A) | | | | Oligomer Amount | Undercoat Layer | |
| | | Weight | | Weight | (Parts) Based on | Presence or | Antioxidant |
| | Monomer | Average | Monomer | Average | 100 Parts of | Absence of | Amount (Parts) |
| | Composition (Weight | Molecular | Composition | Molecular | (meth)acrylic | Undercoat | Based on 100 |
| | Ratio) | Weight | (Weight Ratio) | Weight | Polymer (A) | Layer | Parts of Polymer |
| Example 1 | BA/HBA = 99/1 | 1,800,000 | BA/AA = 98/2 | 4500 | 30 | Present | 100 |
| Example 2 | BA/HBA = 99/1 | 1,800,000 | BA/AA = 98/2 | 4500 | 30 | Present | 100 |
| Example 3 | BA/HBA = 99/1 | 1,800,000 | BA/AA = 98/2 | 4500 | 30 | Present | 100 |
| Example 4 | BA/HBA = 99/1 | 1,800,000 | BA/AA = 98/2 | 4500 | 30 | Present | 300 |
| Example 5 | BA/HBA = 98/2 | 1,800,000 | BA/MA/AA = 78/20/2 | 6000 | 25 | Present | 100 |
| Example 6 | BA/HBA = 98/2 | 1,800,000 | BA/MA/AA = 78/20/2 | 6000 | 25 | Present | 100 |
| Comparative | BA/HBA = 99/1 | 1,800,000 | — | — | — | Absent | — |
| Example 1 | | | | | | | |
| Comparative | BA/HBA = 99/1 | 1,800,000 | BA/AA = 98/2 | 20000 | 25 | Present | 100 |
| Example 2 | | | | | | | |
| Comparative | BA/HBA = 99/1 | 1,800,000 | BA/AA = 95/5 | 4000 | 30 | Present | 100 |
| Example 3 | | | | | | | |
| Comparative | BA/HBA = 99/1 | 1,800,000 | BA/AA = 98/2 | 4500 | 50 | Present | 100 |
| Example 4 | | | | | | | |
| Comparative | BA/HBA = 99/1 | 1,800,000 | BA/AA = 98/2 | 4500 | 30 | Absent | — |
| Example 5 | | | | | | | |
| Comparative | BA/HBA = 99/1 | 1,800,000 | BA/AA = 98/2 | 4500 | 0.2 | Present | 100 |
| Example 6 | | | | | | | |
| Comparative | BA/AA = 99/1 | 1,800,000 | BA/AA = 98/2 | 4500 | 30 | Present | 100 |
| Example 7 | | | | | | | |
| Comparative | BA/AA = 99/1 | 800,000 | BA/AA = 98/2 | 4500 | 30 | Present | 100 |
| Example 8 | | | | | | | |
| Comparative | BA/HBA = 99/1 | 1,800,000 | BA/AA = 98/2 | 4500 | 30 | Present | 0 |
| Example 9 | | | | | | | |

| | Pressure- | | | | |
|---|---|---|---|---|---|
| | Sensitive | | | | |
| | Adhesive Layer | | | | |
| | Antioxidant | | | | |
| | Amount (Parts) | | | | |
| | Based on 100 | | Evaluations | | |
| | Parts of | Protective | | Window | |
| | (meth)acrylic | Film | Peripheral | Frame | |
| | Polymer (A) | Type | Unevenness | Unevenness | Durability |
| Example 1 | 0 | Arton | ⊙ | ⊙ | ⊙ |
| Example 2 | 0 | Zeonor | ⊙ | ⊙ | ⊙ |
| Example 3 | 0 | TAC | ◯ | ⊙ | ◯ |
| Example 4 | 0 | TAC | ◯ | ⊙ | ◯ |
| Example 5 | 0 | Arton | ⊙ | ⊙ | ⊙ |
| Example 6 | 0 | TAC | ◯ | ⊙ | ◯ |
| Comparative | 0 | TAC | X | X | X |
| Example 1 | | | | | |
| Comparative | 0 | TAC | Δ | ◯ | X |
| Example 2 | | | | | |
| Comparative | 0 | TAC | ◯ | ◯ | X |
| Example 3 | | | | | |
| Comparative | 0 | TAC | X | ◯ | X |
| Example 4 | | | | | |
| Comparative | 0 | TAC | ◯ | X | ◯ |
| Example 5 | | | | | |
| Comparative | 0 | TAC | X | ◯ | X |
| Example 6 | | | | | |
| Comparative | 0 | TAC | X | ◯ | X |
| Example 7 | | | | | |
| Comparative | 0 | TAC | Δ | ◯ | X |
| Example 8 | | | | | |
| Comparative | 1 | TAC | ◯ | ◯ | ◯ |
| Example 9 | | | | | |

In Table 1, MA indicates methyl acrylate.

What is claimed is:

1. A pressure-sensitive adhesive optical film, comprising:
an optical film comprising a transparent base film and a discotic liquid crystal layer provided on one side of the transparent base film;
an undercoat layer; and
a pressure-sensitive adhesive layer provided on the discotic liquid crystal layer with the undercoat layer interposed therebetween,
the undercoat layer comprises a polymer and an antioxidant; and
the pressure-sensitive adhesive layer comprises a (meth)acrylic polymer (A) comprising 80 to 99.5% by weight of an alkyl (meth)acrylate monomer unit and 0.05 to 3% by weight of a hydroxyl group-containing monomer unit and having a weight average molecular weight of 1,000,000 to 2,500,000;
a (meth)acrylic oligomer (B) comprising 80 to 99.9% by weight of an alkyl (meth)acrylate monomer unit and 0.1 to 3% by weight of a carboxyl group-containing monomer unit and having a weight average molecular weight of 3,000 to 8,000;
a crosslinking agent (C); and
a silane coupling agent (D), and
the pressure-sensitive adhesive layer comprises 10 to 40 parts by weight of the (meth)acrylic oligomer (B) based on 100 parts by weight of the (meth)acrylic polymer (A).

2. The pressure-sensitive adhesive optical film according to claim 1, wherein the polymer of the undercoat layer has a primary amino group.

3. The pressure-sensitive adhesive optical film according to claim 2, wherein the polymer having the primary amino group is a poly (meth)acrylate having a primary amino group at its end.

4. The pressure-sensitive adhesive optical film according to claim 1, wherein the antioxidant is at least one selected from a phenolic antioxidant, a phosphorus antioxidant, a sulfur antioxidant, and an amine antioxidant.

5. The pressure-sensitive adhesive optical film according to claim 1, wherein the undercoat layer contains 0.01 to 1000 parts by weight of the antioxidant based on 100 parts by weight of the polymer.

6. The pressure-sensitive adhesive optical film according to claim 1, wherein the optical film further comprises a polarizer and a protective film layer laminated on one side of the transparent base film where the discotic liquid crystal layer is not formed with the polarizer interposed therebetween.

7. The pressure-sensitive adhesive optical film according to claim 6, wherein the protective film layer has a water-vapor permeability of 200 g/m² per 24 hours or less at 40° C. and 90% R.H.

8. The pressure-sensitive adhesive optical film according to claim 6, wherein the protective film layer comprises a (meth)acryl-based polymer.

9. An image display, comprising at least one piece of the pressure-sensitive adhesive optical film according to claim 1.
